(19) United States
(12) Patent Application Publication
(10) Pub. No.: US 2005/0221262 A1
(43) Pub. Date: Oct. 6, 2005

(54) Human memory retention and its application to language learning

(76) Inventor: Rongfu Xiao, Fremont, CA (US)

Correspondence Address: Dr.Rongfu Xiao, 43305 Livermore Common, Fremont, CA, 94539, US

(21) Appl. No.: 10/906,995

(22) Filed: Mar. 15, 2005

Related U.S. Application Data
(60) Provisional application No. 60/559,039, filed on Apr. 5, 2004.

(51) Int. Cl. G09B 19/00

(52) U.S. Cl. 434/236

(57) ABSTRACT

This invention deals with human memory retention and its application to language learning or any training process that requires memorization of the old information learned in the early time. A memory retention function with a form of R=A.t^{(d-D)} is used, where R is the percentage (%) of memory retention after a time span t for the content learned earlier, and d is the fractal dimension of the active dendritic neurons in human brain cell, that participate in the learning process, and D (equal either 2 or 3) is a physical dimension. The implication of this human memory retention scheme is that by repeated reviewing, more dendritic neurons become activated (i.e., cross-linked with nearby neurons having certain degree of prior knowledge) resulting in a larger d. This invention proposes a method to estimate the fractal dimension d from the memory activities for each user in language learning process, which provides a way to predict when next memory rehearsal (repetition) is needed before the earlier learned-information are likely forgotten.

This application claims priority under 35 U.S.C. §119(e) of the provisional patent application No. 60/559,039 filed Apr. 05, 2004.

### BACKGROUND OF THE INVENTION

Memorization of what has been learned previously is important in every aspect in our daily life. Without a memory, our human being will not exist. Although the memory capability of our human being is much advanced than any other living beings, it always decays. The earliest scientific observation of memory forgetting was made by a German psychologist Hermann Ebbinghaus in 1885. Since then, there have been many articles about memory retention. Various time dependence of memory retention has been proposed:
[1] W. A. Wickelgren (1977) “Learning and memory”, Englewood Cliffs, Prentice-Hall
[2] J. R. Anderson and L. J. Schooler, “Reflections of the environment in memory”, Psychological Science 2 (1991) 396.
[3] J. T. Wixted and E. B. Ebbesen “On the form of forgetting”, Psychological Science 2 (1991) 409.
[4] D. C. Rubin and A. E. Wenzel, “One hundred years of forgetting: A quantitative description of retention”, Psychological Review, 103 (1996) 734.
   Unfortunately, all of the earlier works concentrate on experimental curve fitting, and none of them explain fundamentally why the memory retention function should behave like that.

### SUMMARY OF THE INVENTION

This invention reveals the physical meaning of the memory retention function, i.e., R˜t^{(d-D)}, in terms of the fractal dimension of the dendritic neurons in human brain cell actively participating in the learning process. With increasing number of repetition, more neurons get activated (connected), which results in a step-wise increase in fractal dimension d. Through a continuing monitoring of memorization process, the fractal dimension d can be iteratively calculated and timely adjusted for each user. Any user can use the result to provide a just-right-time review to quickly learn a new language.

### BRIEF DESCRIPTION OF THE DRAWINGS

FIG. 1 An schematic view of neuron activation under the influence of repeated information impulses. As the result, memory retention becomes stronger and longer due to an increase of the fractal dimension of the activated neurons.

FIG. 1a: Initial state: all neurons are inactive (idle),

FIG. 1b: An information impulse activates some neurons,

FIG. 1 c: Repeated impulses activate more neurons, and links between different neurons are established, which results in a larger fractal dimension for active neurons.

FIG. 2 Time dependence of memory retention at different fractal dimensions for the activated neurons. With increasing fractal dimension, memory retention becomes stronger and better.

FIG. 3 Numerical result of repeated memorization processes. A new memory rehearsal is given before memory retention drops below certain level (for instance, 50%). Through a series of timely review, the information is encoded deeply in a human's mind (i.e., the forgetting rate become weaker and smaller), changing from short-term memory to long-term memory.

FIG. 4 Experimental results showing the time-dependence of repeated learning process for English language learning for two different users (User A and B). Those “sudden drops” on the curve indicate the reviewing of the old words learned previously. As one can see that different user has different learning speed.

### BRIEF DESCRIPTION OF THE INVENTION

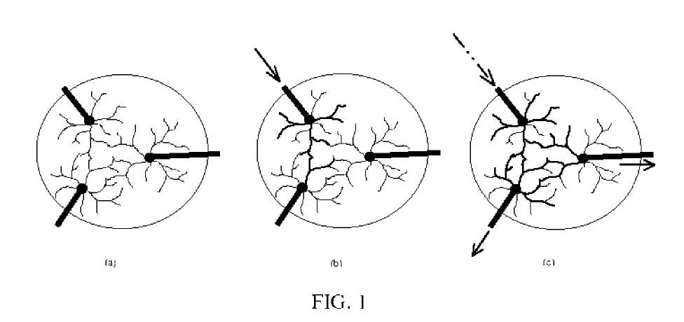

This invention relates the memory retention during language learning to the fractal dimension of neurons (FIG. 1) that actively participate in the learning process in human brain. The ultimate goal is to provide a “just-right-time” reviewing scheme to speed up language learning process and to avoid any redundant time.

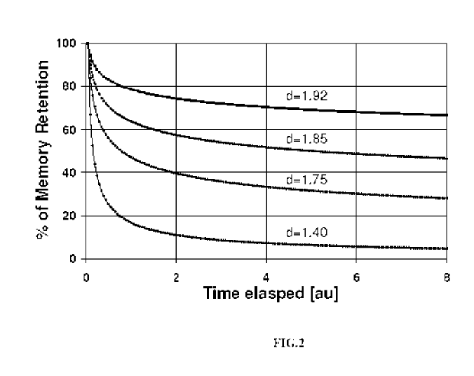

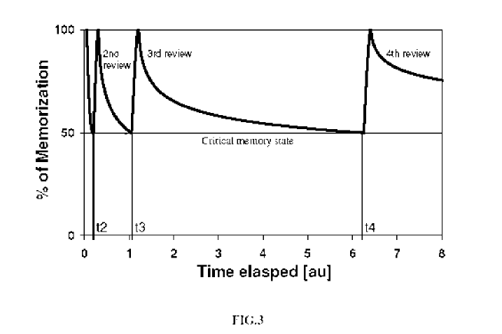

The idea is based on the activation of inactive neurons by information impulse via human information sensors. The impulse transmits the information from one neuron to another via their biological dendrite (more detailed activation involves synaptic transmission and action potential), Through repeated memory rehearsal (FIG. 3), more and more neurons get connected (activated, see FIG. 1c), and the fractal dimension of the active neurons become larger and the memorization retention become stronger (upper curve in FIG. 2).

### DETAILED DESCRIPTION OF THE INVENTION

To remember longer and stronger, a timely rehearsal is a must-to-do action. FIG. 3 shows how a series of successive review improves memory retention. After the first review, the memory retention is very weak and the information just learned is quickly lost. However, as the number of review increases, more and more neurons get connected (FIG. 1c), resulting larger fractal dimensions. As the result, memory retention ability becomes better and stronger. There is a critical time beyond which the memory cannot recover what has been learned. The (50% retention) horizontal line in FIG. 3 is such a critical line that defines the next reviewing time for each review. A too-short or too-long reviewing time will be either unnecessary (a waste of time) or too-late to prevent what has been learned from being completely lost. In other words, to achieve an efficient memorization, one should designs a just-right-time review using the horizontal critical line as guidance.

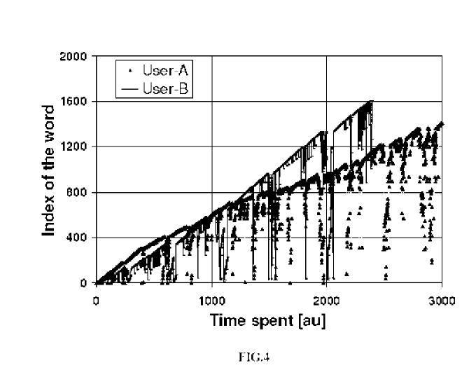

The memorization retention for different learner is very different, and different for different new word even for the same learner. FIG. 4 shows actual rehearsal sequences for two learners during the learning process of some English vocabulary. The vertical axis represents the index of the word list and horizontal is the time elapsed (in an arbitrary time scale) during the learning process. Those sudden “drop” in this figure indicates review of the old word before proceed to learn more new vocabulary. As can be seen from this figure, User-B learns much faster than User-A. Also, the reviewing sequences are very different. To remember the same amount of words, User-A spent much more time in reviewing the old words. The memory retention for User-B is much better than User-A, indicating more active neurons participating in the learning process in User-B's mind than User-A. Thus, the language learning process must be treated separately for different

1. The physical representation of the neurons in human brain cell is fractal-like.

2. The number (N) of activated neurons (density d, per unit volume in brain cell) mentioned in claim 1 can be described by a scaling law N˜r^{(d-D)}, where r is a liner parameter defining the size of the region considered (such as, a radius), and D is the physical dimension equal either 2 (for two dimension) or 3 (three dimension).

3. The nature of repeated learning is to increase the density of activated neurons described in claims 1-2, i.e., to increase the fractal dimension d.

4. The fractal dimension of the activated neurons described in claims 1-3 can be estimated by the response of either “Known” or “Unknown” from the user who is participating in the learning process.

5. The fractal dimension (d) as described in claim 4 increases in a step-wise manner, d₁, d₂, d₃, . . . with the number of repeated learning i (1, 2, 3, . . . ).

6. The density of the activated neurons described in claim 2 is directly related to the memory retention ability in human's brain.

7. The time dependence of memory retention (R—% of memorization at time t after an immediate review) can be described by R˜t^{(d-D)}.

8. An effective learning sequence can be designed in a “just-right-time” fashion using an iterative method based on the concept of fractal dimension d described in claims 2-5. To be more specific, the memory retention Rᵢ for i^{th} repeating at time t can be written as Rᵢ=A.t^{(di-D)}, where A is a scaling constant.

9. The learning scheme described in claim 8 is suitable for any language learning, or any training process that requires memorization of the old information learned in the early time.
